(19) United States
(12) Patent Application Publication
(10) Pub. No.: US 2011/0133099 A1
(43) Pub. Date: Jun. 9, 2011

(54) SILICON CONCENTRATION MEASURING INSTRUMENT

(75) Inventors: Koji Uchimura, Uji-shi (JP); Yoshiro Matano, Kyoto (JP)

(73) Assignee: HORIBA ADVANCED TECHNO, CO., LTD., Kyoto (JP)

(21) Appl. No.: 13/056,801

(22) PCT Filed: Jul. 6, 2009
(86) PCT No.: PCT/JP2009/062321

§ 371 Date: Jan. 31, 2011

(30) Foreign Application Priority Data
Jul. 30, 2008 (JP) 2008-196092

(51) Int. Cl. G01N 21/49; G01N 21/64

(52) U.S. Cl. 250/458.1; 356/338

(57) ABSTRACT

The present invention is an instrument that detects a trace amount of silicon contained in a sample solution with simple means and measures a silicon concentration in the sample solution, and adapted to include: an excitation light irradiation part that irradiates the sample solution with excitation light for silicon; a light detection part that detects fluorescence and/or scattering light emitted from silicon in the sample solution irradiated with the excitation light; and a calculation part that calculates the silicon concentration in the sample solution from intensities or an intensity of the fluorescence and/or the scattering light.

### TECHNICAL FIELD

The present invention relates to a silicon concentration measuring instrument that detects a trace amount of silicon contained in a sample solution with simple means.

### BACKGROUND ART

For a mask to form an element isolation oxide film (SiO₂ film) on a silicon semiconductor wafer by a LOCOS (LoCal Oxidation of Silicon) method, a nitride film (Si₃N₄ film) is used, and to remove such a nitride film, a so-called wet etching method using hot concentrated phosphoric acid is generally used.

As an instrument for performing the wet etching method, there is known a wet etching instrument that dips a silicon semiconductor wafer in which nitride and oxide films are patterned into a cleaning tank in which hot concentrated phosphoric acid is circulated, and thereby dissolves and removes only the nitride film.

When the wafer formed with the nitride film is dipped into the cleaning tank of such a wet etching instrument, etching of the nitride film by the hot concentrated phosphoric acid progresses; however, during the etching, a Si component in the nitride film is dissolved out into the hot concentrated phosphoric acid to exist in the solution as compounds of silicon (hereinafter referred to as silica).

It is thought that silica remains dissolved in the hot concentrated phosphoric acid at low concentration; however, when by repeatedly using the hot concentrated phosphoric acid for the nitride film removal processing, a silica concentration is increased to bring silica into an oversaturated state, and silica precipitates. Then, silica precipitated in the hot concentrated phosphoric acid is deposited on an inner wall of circulating system piping for the hot concentrated phosphoric acid, including a pump and a filter, to give rise to a problem of interfering with the circulation.

For this reason, it is extremely important to monitor the silica concentration in the hot concentrated phosphoric acid (Patent literatures 1 and 2); however, silica contained in the hot concentrated phosphoric acid is in as extremely minute trace amounts as a few tens of ppm to a few hundreds of ppm.

In general, in order to measure such a trace component with high sensitivity, as a direct quantitative method, an atomic absorption analysis method, inductively-coupled plasma (ICP) emission spectrometry, or ICP spectrometry is used; however, an analyzer for such a method is large and expensive, and therefore not suitable for simple measurement. Also, as a chemical analysis method for a trace component, a molybdenum blue method is known; however, to measure the silica concentration in the hot concentrated phosphoric acid, the phosphoric acid serves as an interfering substance, and therefore this method is not suitable.

Further, the hot concentrated phosphoric acid has a concentration of 85% and a temperature of 160° C., and therefore to directly quantify silica in the hot concentrated phosphoric acid, it is necessary to sample the hot concentrated phosphoric acid from the wet etching instrument after it has cooled to around room temperature; however, for this reason, there are problems in that the temperature condition for sampling is largely different from that in an actual process, and it takes a lot of time to make the measurement, and other problems.

On the other hand, to indirectly measure the silica concentration in the hot concentrated phosphoric acid, an electrical conductivity is generally measured. However, this method is difficult to discriminate between silica being measured and the other components; therefore this method obtains only empirical information on the basis of a result of the measurement, and as a result is not suitable in the case of requiring accuracy.

### CITATION LIST

### PATENT LITERATURE

Patent literature 1: JP 2006-352097 A

Patent literature 2: JP 2003-158116A

### SUMMARY OF THE INVENTION

### Technical Problem

Therefore, the present invention is intended to provide a silicon concentration measuring instrument that detects a trace amount of silicon contained in a sample solution with simple means.

### Solution to the Problem

That is, a silicon concentration measuring instrument according to the present invention is an instrument that measures a silicon concentration in a sample solution, and includes: an excitation light irradiation part that irradiates the sample solution with excitation light for silicon; a light detection part that detects fluorescence and/or scattering light emitted from silicon in the sample solution, the silicon being irradiated with the excitation light; and a calculation part that calculates the silicon concentration in the sample solution from intensities or an intensity of the fluorescence and/or scattering light. In addition, it is thought that silicon that is a measurement object of the present invention is present in the sample solution as compounds of silicon and oxygen, and among them, in many cases, present as oxide of silicon such as silicon dioxide.

Silica emits fluorescence in a region of ultraviolet light to visible light in any of an ionic state and a colloidal state. Also, for the wet etching instrument that uses the hot concentrated phosphoric acid, the piping for supply or circulation is made of fluororesin having high optical transparency in the region of ultraviolet light to visible light, or quartz piping is used.

Accordingly, by using the silicon concentration measuring instrument according to the present invention to irradiate the hot concentrated phosphoric acid flowing through the piping from outside of the piping with, as excitation light, light having a wavelength that causes silica to emit fluorescence or various types of scattering light such as a front scattering light or back scattering light, silica in the hot concentrated phosphoric acid emits fluorescence, and by measuring an intensity of the fluorescence, a concentration of silica present in the hot concentrated phosphoric acid can be quantified.

For this reason, according to the present invention, when the silica concentration in the hot concentrated phosphoric acid is quantified, it is not necessary to sample the hot concentrated phosphoric acid as a sample fluid, so that as a result, risk of contact with the hot concentrated phosphoric acid that is at high temperature and is a strong acid can be avoided, and also an amount of the hot concentrated phosphoric acid consumed by the measurement and an amount of a waste solution associated with the measurement can be reduced. Also, according to the present invention, the hot concentrated phosphoric acid flowing through the piping of the wet etching instrument can be made to serve as a sample solution, and therefore the measurement can be made under a condition (temperature and the like) closer to that used in an actual process, and can also be made accurately and quickly. Further, according to the present invention, continuous concentration control of the hot concentrated phosphoric acid can be performed in real time, and therefore adequate operational control of an etching rate and the like, and reproduction control of the hot concentrated phosphoric acid, can be performed.

In order to enable the present instrument to be installed even in the case where a sufficient space cannot be ensured around the piping, the excitation light irradiation part or the light detection part is preferably provided with a waveguide such as an optical fiber and a light reflector such as a prism. If so, only the light reflector is required to be directly installed in the piping, and from or to the light reflector, the waveguide can be used to transmit light, so that the light source or light receiver (including the spectroscope) may be installed in a position distant from the piping, and therefore an installation position of the light source or the light receiver can be freely selected.

### ADVANTAGEOUS EFFECTS OF THE INVENTION

Thus, according to the present invention, securely and without discharging any waste solution, a silica concentration can be accurately and quickly measured under a condition (temperature and the like) close to that in an actual process.

### BRIEF DESCRIPTION OF THE DRAWINGS

FIG. 1 is a configuration diagram of a silica concentration measuring instrument according to one embodiment of the present invention.

FIG. 2 is a configuration diagram of an information processor of the same embodiment.

FIG. 3 is a flowchart illustrating a method for measuring a silica concentration of the same embodiment.

### DESCRIPTION OF THE EMBODIMENTS

One embodiment of the present invention will hereinafter be described referring to the drawings.

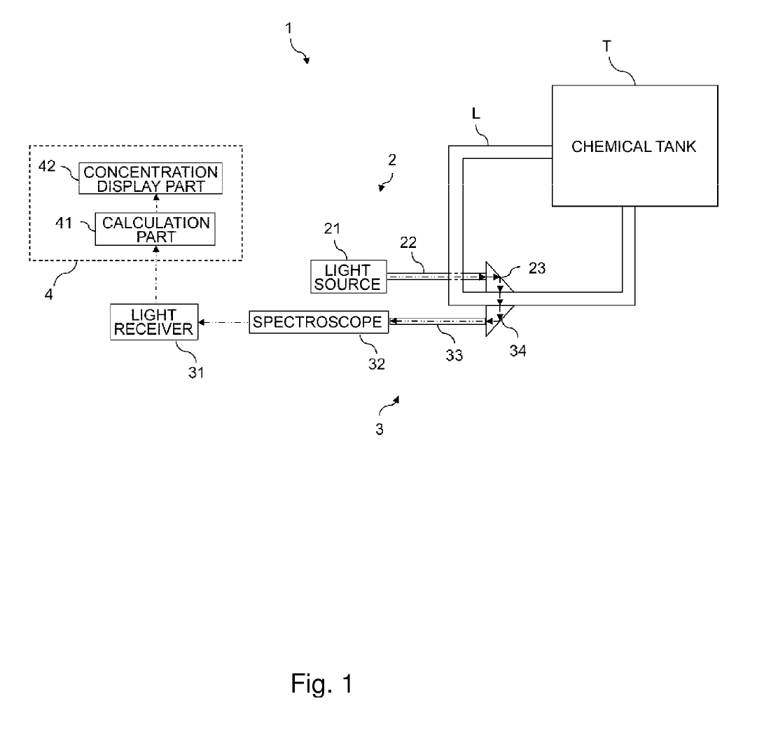

A silica concentration measuring instrument 1 according to the present embodiment is an instrument that is installed in piping L that is connected to a chemical tank T storing a solution of hot concentrated phosphoric acid and made of a light transmissive material, and measures a silica concentration in the hot concentrated phosphoric acid, and as illustrated in FIG. 1, provided with: an excitation light irradiation part 2 that irradiates the hot concentrated phosphoric acid with excitation light; a light detection part 3 that receives light emitted from silica in the hot concentrated phosphoric acid; and an information processor 4 that functions as a calculation part 41 calculating the silica concentration in the hot concentrated phosphoric acid from an intensity of the light, and other parts.

In the following, the respective parts are described. The excitation light irradiation part 2 is provided with a light source 21 including a xenon lamp, an ultraviolet LED, or the like, an optical fiber 22, and a prism 23, and is a part that transmits light emitted from the light source 21 to the piping L through the optical fiber 22; fully reflects the transmitted excitation light on the prism 23; and irradiates the hot concentrated phosphoric acid circulating in the piping L with the reflected light. The excitation light is, for example, light having a wavelength of 180 to 1200 nm, and preferably light having a wavelength of 180 to 460 nm.

The light detection part 3 is provided with a light receiver 31, a spectroscope 32, an optical fiber 33, and a prism 34, and is a part that fully reflects fluorescence and various types of scattering light emitted from silica in the hot concentrated phosphoric acid on prism 34; transmits them through the optical fiber 33; and receives light having, for example, a wavelength of 180 to 720 nm, preferably a wavelength of 180 to 500 nm, with the light receiver 31, which is spectroscopically obtained by the spectroscope 32, to detect an emission amount. Note that a wavelength range in which the fluorescence and various types of scattering light are detected is not limited to this range, but varies depending on a wavelength of the excitation light.

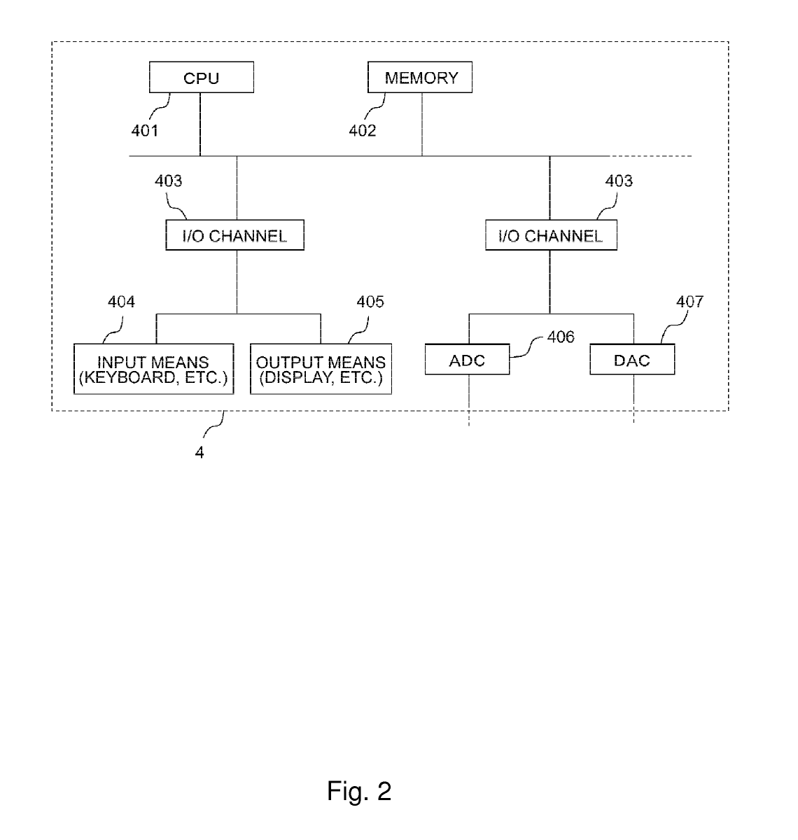

The information processor 4 is a general purpose or dedicated one that is, as illustrated in FIG. 2, provided with, in addition to a CPU 401, a memory 402, an input/output channel 403, input means 404 such as a keyboard, output means 405 such as a display, and the like, and the input/output channel 403 is connected with an A/D converter 406, a D/A converter 407, and an analog/digital conversion circuit such as an amplifier (not illustrated).

The information processor 4 is configured to store a predetermined program in the memory 402 thereof, and according to the program, cooperatively operate the CPU 401 and the peripheral devices thereof to fulfill functions as the calculation part 41, the concentration display part 42, and the like.

The calculation part 41 performs predetermined calculation processing of the emission amount of the light having the wavelength of 180 to 720 nm emitted from silica to thereby calculate the silica concentration in the hot concentrated phosphoric acid.

The density display part 42 acquires data on the silica concentration calculated in the calculation part 41 to display it as characters or an image.

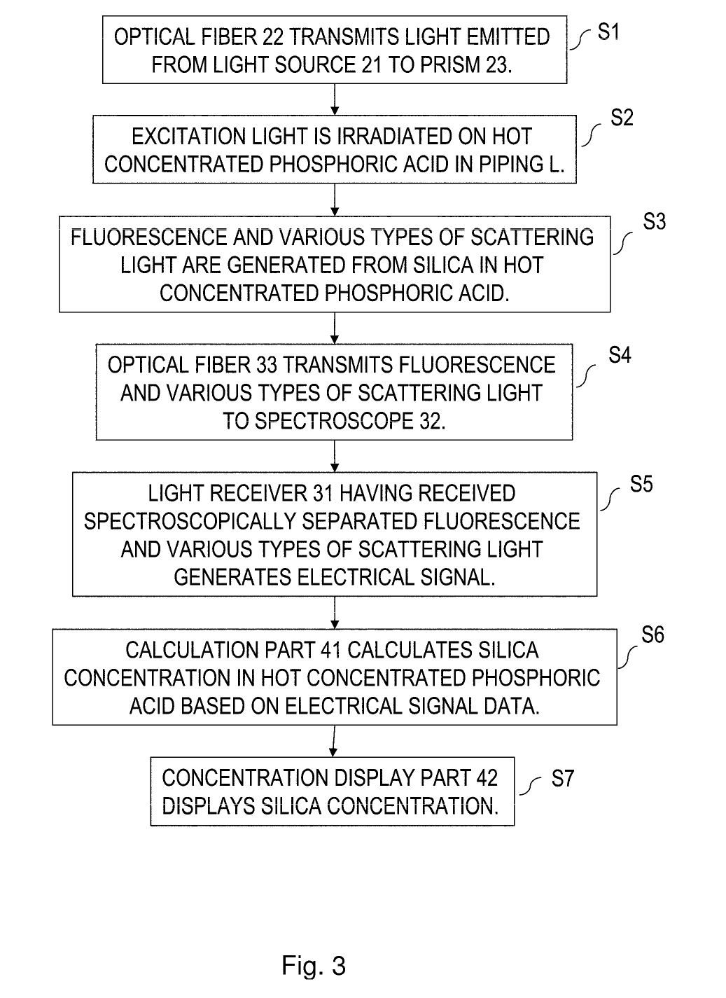

Next, a procedure for using the silica concentration measuring instrument 1 to measure the silica concentration in the hot concentrated phosphoric acid is described referring to a flowchart in FIG. 3.

First, when the light source 21 emits light, the emitted excitation light is introduced into the optical fiber 22, and transmitted to the prism 23 provided at an end of the optical fiber 22 (Step S1).

The excitation light transmitted to the prism 23 is fully reflected on the prism 23 to change a traveling direction thereof, and transmits through a light transmissive wall of the piping L to be irradiated on the hot concentrated phosphoric acid circulating inside the piping L (Step S2.)

When the excitation light is irradiated on the hot concentrated phosphoric acid circulating inside the piping L, fluorescence and various types of scattering light such as front scattering light and back scattering light are emitted from silica in the hot concentrated phosphoric acid (Step S3).

The fluorescence and various types of scattering light transmit through the wall of the piping L; are fully reflected on the prism 34; are introduced into the optical fiber 33 to be transmitted to the spectroscope 32; and are spectroscopically separated by the spectroscope 32 (Step S4).

Then, the light receiver 31 receives the spectroscopically separated fluorescence and various types of scattering light, and transmits an electrical signal depending on an emission amount of the received light (Step S5).

The calculation part 41 receives the electrical signal from the light receiver 31, and performs the predetermined calculation processing on the basis of data corresponding to the electrical signal to calculate the silica concentration in the hot concentrated phosphoric acid (Step S6)

The concentration display part 42 acquires data on the silica concentration from the calculation part 41 to display the data as characters or an image (Step S7).

Thus, according to the silica concentration measuring instrument 1 configured as described above according the present embodiment, when the silica concentration in the hot concentrated phosphoric acid is quantified, it is not necessary to sample the hot concentrated phosphoric acid as a sample solution, so that as a result, risk of contact with the hot concentrated phosphoric acid that is at high temperature and is a strong acid can be avoided, and also an amount of the hot concentrated phosphoric acid consumed by the measurement and an amount of a waste solution associated with the measurement can be reduced. Also, according to the present embodiment, the hot concentrated phosphoric acid flowing through the piping L can be made to serve as a sample solution, and therefore the measurement can be made under a condition (temperature and the like) closer to that in an actual process, and also can be made accurately and quickly. Further, according to the present embodiment, continuous concentration control of the hot concentrated phosphoric acid can be performed in real time, and therefore adequate operational control of an etching rate and the like, and reproduction control of the hot concentrated phosphoric acid, can be performed.

Also, in the present embodiment, only the prisms 23 and 34 are directly installed in the piping L, and light can be transmitted to the prism 23 or from the prism 34 with use of the optical fiber 22 or 33, so that an installation position of the light source 21 or the light receiver 31 can be freely selected, and even in the case where a sufficient space cannot be ensured around the piping L, the silica concentration measuring instrument 1 can be installed.

Note that the present invention is not limited to the above-described embodiment.

For example, the sample solution is not limited to the hot concentrated phosphoric acid, but can be appropriately selected.

Also, the waveguide is not limited to the optical fiber, and the light reflector is also not limited to the prism.

If the silica concentration is low and thereby intensities of the fluorescence and various scattering light are extremely low, or it is difficult to construct the optical fiber 22 or 33 because a distance between the piping and the light source 21 or light receiver 31 is long, any one or both of the light source 21 and the light receiver 31 (which may include the spectroscope 32) may be installed in the piping L without use of the optical fiber 22 or 33 or prism 23 or 34.

If a radio wave can be used and it is difficult to provide the optical fibers 22 and 33 respectively having sufficient lengths, connections between the optical fibers 22 and 33 and the light source 21 and light receiver 31 (including the spectroscope 32) may be further made by radio.

In addition, it should be appreciated that part or all of the above-described embodiment and variations may be appropriately combined, and various modifications can be made without departing from the scope of the present invention.

### INDUSTRIAL APPLICABILITY

By applying the present invention, a trace amount of silicon contained in a sample solution can be detected with simple means.

### REFERENCE CHARACTERS LIST

1: Silicon (silica) concentration measuring instrument
2: Excitation light irradiation part
: Light detection part
4: Information processor
41: Calculation part

1. A silicon concentration measuring instrument that measures a silicon concentration in a sample solution, the silicon concentration measuring instrument comprising:
an excitation light irradiation part that irradiates the sample solution with excitation light for silicon;
a light detection part that detects fluorescence and/or scattering light emitted from silicon in the sample solution, the silicon being irradiated with the excitation light; and
a calculation part that calculates the silicon concentration in the sample solution from intensities or an intensity of the fluorescence and/or scattering light.

2. The silicon concentration measuring instrument according to claim 1, wherein
the sample solution is a phosphoric acid solution.

3. The silicon concentration measuring instrument according to claim 1, wherein
the excitation light irradiation part or the light detection part comprises a waveguide and a light reflector.
